(19) United States
(12) Patent Application Publication
(10) Pub. No.: US 2012/0085912 A1
(43) Pub. Date: Apr. 12, 2012

(54) TOMOGRAPHIC IMAGING SYSTEM FOR ACQUIRING PET/SPECT AND CT IMAGE DATA

(75) Inventors: William K McCroskey, Solon, OH (US); Christ H. Heipp, Mantub, OH (US); William D. Dickinson, North Field, OH (US)

(73) Assignee: FMI TECHNOLOGIES, INC., Akron, OH (US)

(21) Appl. No.: 13/269,606

(22) Filed: Oct. 9, 2011

Related U.S. Application Data
(60) Provisional application No. 61/391,623, filed on Oct. 9, 2010.

(51) Int. Cl. G01T 1/164

(52) U.S. Cl. 250/363.03

(57) ABSTRACT

Some embodiments of the present invention generally relate to a common PET/SPECT/CT gantry including a central aperture. At least one x-ray source can be mounted on the common gantry in a fixed relation, wherein an x-ray beam emitted by the source is directed across the central aperture. Some embodiments can also include a plurality of x-ray scintillation detectors mounted on the common gantry in a fixed relation and directed in an opposing orientation relative to the at least one x-ray source. In some embodiments a plurality of PET/SPECT scintillation detectors is also mounted on the common gantry in a fixed relation, wherein the PET/SPECT detectors define an arc having a center in common with the central aperture.

### I. CROSS REFERENCE TO RELATED APPLICATIONS

This invention claims priority to U.S. Provisional Patent Application No. 61/391,623 filed Oct. 9, 2010 and now pending, and which is incorporated by reference in its entirety.

### II. BACKGROUND OF THE INVENTION

A. Field of Invention

This invention generally relates to devices and methods for obtaining PET, SPECT and X-ray CT imaging data.

B. Description of the Related Art

PET and SPECT are fundamentally different from x-ray CT, although they may utilize some similar hardware elements and similar image reconstruction algorithms. Particularly, PET and SPECT images are made by administering a radiopharmaceutical tracer species to a patient, which collects in a target tissue or organ. As the tracer decays it emits positrons, which annihilate and form gamma photons that radiate isotropically in all directions from within the patient. Thus, gamma photons emanate from the target tissue or organ and are detected. This data is then used to reconstruct a two dimensional slice image of the target structure. Since gamma photons emit isotropically from the patient, it may or may not be necessary to rotate the detectors about the patient, depending on whether the detectors fully encircle the patient.

In contrast, x-ray CT is a transmission method where an x-ray beam passes through a patient and is attenuated by the patient's body. The attenuated beam is then detected by one or more x-ray detectors. Since different tissues and structures within the body attenuate x-rays to differing degrees, an intensity contrast image can be formed. Furthermore, since the x-ray beam is essentially unidirectional the source generally must be rotated around the patient so that data can be collected from all angles, which is necessary in order to reconstruct a two dimensional slice image.

It is known in the art to have PET, SPECT and CT imaging elements incorporated into a single tomographic imaging apparatus. For instance, it is known that CT data can be used to correct PET and SPECT imaging data. More particularly, since gamma photons can be formed at varying depths within a patient, gamma photons emanating from structures deeper within the patient will tend to be more attenuated than gamma photons formed closer to the body's surface. Additionally, some structures such as bone are more efficient at absorbing gamma photons than others such as soft tissue. For instance, if a structure in the chest is being imaged by PET or SPECT methods, the rib cage is likely to cause obstructions in the image and thereby degrade its quality. Accordingly, it is known to use x-ray CT data to correct for the effect of surrounding body structures.

In order to obtain accurately corrected PET/SPECT data the patient must remain still between x-ray CT and PET/SPECT scans so that the structures imaged in CT are in the same position during the PET/SPECT measurement. Thus, the more time that is required to collect all of the CT and PET/SPECT data, the more likely that the patient will move to some degree and therefore degrade image quality. Unfortunately, prior instruments required users to obtain CT and PET/SPECT image data separately. Thus, patient movements are problematic.

Accordingly, what is needed is a device and/or method for concurrently obtaining CT and PET/SPECT data. Some embodiments may provide these and/or other advantages over the prior art.

### III. SUMMARY OF THE INVENTION

Some embodiments of the present invention relate to a PET/SPECT/CT apparatus, comprising: a common gantry defining a generally circular outer perimeter and a generally circular inner perimeter, wherein the inner perimeter defines a central aperture, and wherein the common gantry comprises one degree of rotational freedom; at least one x-ray source mounted on the common gantry in a fixed relation, wherein an x-ray beam emitted by the source is directed across the central aperture; a plurality of x-ray scintillation detectors mounted on the common gantry in a fixed relation and directed in an opposing orientation relative to the at least one x-ray source, wherein the plurality of x-ray scintillation detectors define an arc having a center located near the at least one x-ray source; and a plurality of PET/SPECT scintillation detectors mounted on the common gantry in a fixed relation, wherein the PET/SPECT detectors define an arc having a center in common with the central aperture, and wherein the plurality of PET/SPECT detectors are spaced apart from the plurality of x-ray scintillation detectors in a z-direction.

According to some embodiments the common gantry further comprises one degree of freedom in the φ direction.

According to some embodiments the inner perimeter and outer perimeter share a common center.

According to some embodiments the at least one x-ray source emits a fan beam.

According to some embodiments the plurality of x-ray scintillation detectors comprises one or more scintillation crystals selected from cerium doped lutetium yttrium orthosilicate (LYSO), sodium doped cesium iodide (Na:CsI), bismuth germinate (BGO), cerium doped gadolinium orthosilicate (GSO), thallium doped sodium iodide (Tl:NaI), barium fluoride (BaF₂), cerium doped yttrium aluminate (YAlO₃, i.e. YAP), cerium doped lutetium oxyorthosilicate (Ce:Lu₂SiO₅, i.e. LSO), lanthanum bromide (LaBr₃), cerium doped lanthanum bromide, or any combination thereof.

According to some embodiments each of the plurality of x-ray scintillation detectors comprises an array of scintillation crystals optically isolated from each other by reflective media, and wherein the size of the arrays is selected from one or more of 8×8, 16×16, 32×32 64×64 or 128×128.

According to some embodiments PET/SPECT and CT data are collected according to an interlaced pattern.

Other benefits and advantages will become apparent to those skilled in the art to which it pertains upon reading and understanding of the following detailed specification.

### IV. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a frontal view of an embodiment; and

FIG. 2 is a perspective view of an embodiment illustrating a coordinate system.

### V. DETAILED DESCRIPTION OF THE INVENTION

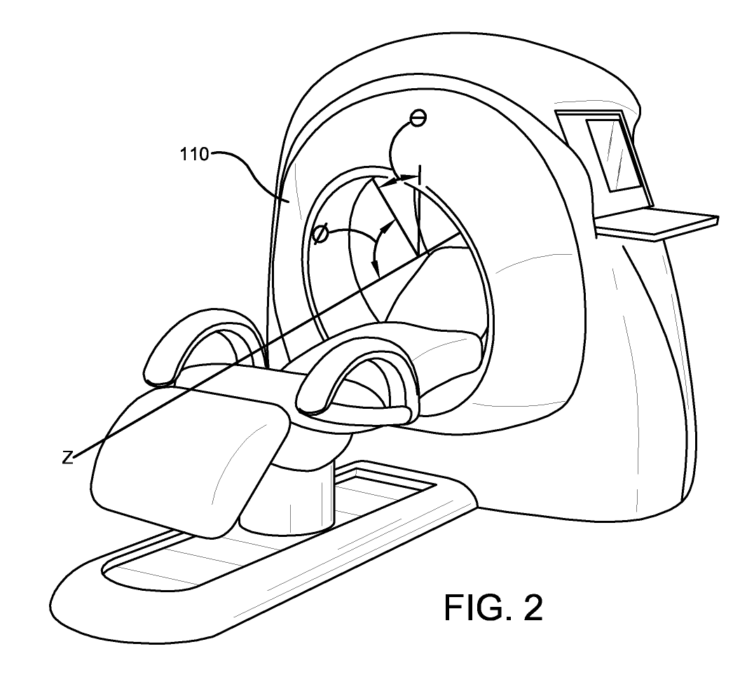

A cylindrical coordinate system is used herein to define orientations, positions and directions relative to a tomographic imaging system, which is shown in FIG. 2. As used herein, the z coordinate defines a linear axis orthogonal to, and passing through, a central point of a gantry. A theta (θ) coordinate indicates an angle of a radius orthogonal to the z axis, which can vary continuously from 0 to 360 about the z axis relative to an origin. The phi (φ) variable indicates an angle between the z axis and a radius orthogonal to the z axis.

According to some embodiments, PET/SPECT and CT detectors are mounted on a common rotating plate, i.e. a common gantry and are adapted to acquire PET and CT and/or SPECT and CT images in a substantially concurrent manner. For example, some embodiments are adapted to collect PET/SPECT and CT data defining a full two-dimensional image slice during a single gantry revolution.

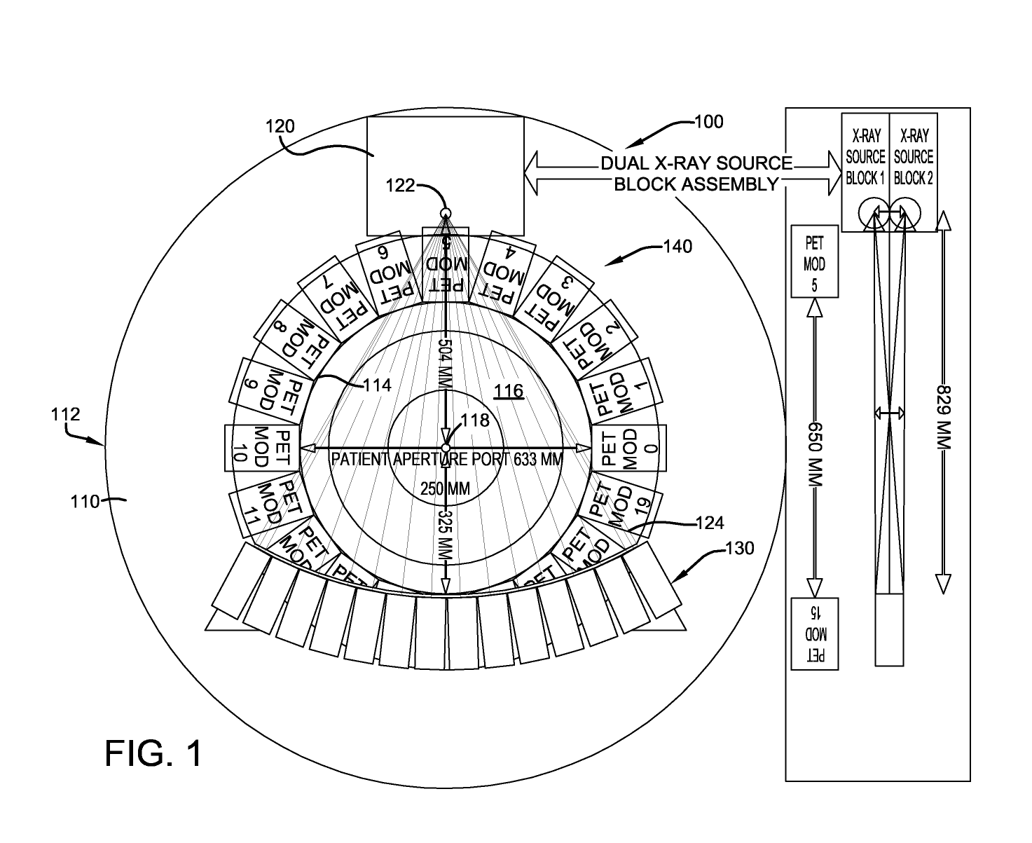

According to an embodiment 100 shown in FIG. 1, a gantry 110 defines an outer perimeter 112 and an inner perimeter 114. The inner perimeter further defines a central aperture 116. The inner and outer perimeters 112, 114 share a common center 118. An x-ray source 120 is fixedly mounted on the gantry 110 and includes at least one x-ray emitting anode 122. The anode 122 emits x-rays 124 in a fan beam pattern, which traverse the central aperture 116 and pass through a subject disposed therein. The subject, such as a human patient, attenuates the x-ray beam 124, which is transmitted through the subject. The transmitted x-ray beam is then detected by a plurality of x-ray scintillation detectors 130 which are arranged defining an arc and are mounted to the gantry 110 in a fixed relation. The arc of detectors 130 has a center point at approximately the position of the anode 122. The embodiment 100 further comprises a plurality of PET/SPECT detectors 140 mounted to the gantry 110 in a fixed relation. The PET/SPECT detectors 140 are configured to define a generally circular pattern extending over a full circumference. The generally circular pattern has a center point 118 in common with the inner and outer circumferences 112, 114 of the gantry 110. According to the embodiment 100 of FIG. 1 the PET/SPECT detectors are offset from the x-ray scintillation detectors in the z-direction. Accordingly, fields of view of the PET/SPECT and CT detectors are adjacent to one another, and may overlap to some degree.

In some embodiments, sufficient PET/SPECT and/or CT data can be acquired through one complete revolution of the gantry 110 to reconstruct a single two dimensional slice image. Furthermore, in some embodiments a three dimensional image can be reconstructed by additionally continuously translating the subject relative to the gantry in the z-direction, thereby acquiring data in a helical pattern. In other embodiments, a three dimensional image can be reconstructed by rotating the gantry through one full revolution, stepping the patient a distance Δz through the gantry, and executing another data collection revolution of the gantry. Repeating this process N times produces a multi-slice three dimensional image N slices deep. Still further, in some embodiments CT data can be acquired along with PET/SPECT data in an alternating or interlaced pattern. For instance, at a given θ₁ position of the gantry, the x-ray data can be collected followed by the PET/SPECT data. The gantry can then be moved by a step of Δθ to θ₂ where CT data is again collected followed by PET/SPECT data. This process can be repeated as many times as necessary to obtain sufficient tomographic data for a desired image. Furthermore, interlaced data collection can be executed in combination with step and shoot and/or helical scanning protocols.

In another embodiment, CT data and PET/SPECT data can be acquired simultaneously. In such embodiments, the system may be adapted to distinguish between x-ray photons and gamma photons thereby avoiding cross talk noise. For example, if an x-ray photon causes a scintillation event and/or is detected by the PET/SPECT detector this scintillation event can identified as resulting from an x-ray photon and can be rejected. In some embodiments, cross talk noise can be sufficiently mitigated using appropriate collimating filters to remove x-ray and/or gamma photons as necessary. In still other embodiments scintillation crystals and collimating filters can be chosen so that the CT detectors are not sensitive to gamma radiation and/or the PET/SPECT detectors are not sensitive to x-ray radiation.

The embodiments have been described hereinabove and shown in the various drawing views, which are included for purposes of illustrating embodiments of the invention and not for limiting the same. Thus, it will be apparent to those skilled in the art that the above methods and apparatuses may incorporate changes and modifications without departing from the general scope of this invention. Accordingly, it is intended to include all such modifications and alterations insofar as they come within the scope of the appended claims or the equivalents thereof.

Having thus described the invention, it is now claimed:

1. A PET/SPECT/CT apparatus, comprising:
a common gantry defining a generally circular outer perimeter and a generally circular inner perimeter, wherein the inner perimeter defines a central aperture, and wherein the common gantry comprises one degree of rotational freedom;
at least one x-ray source mounted on the common gantry in a fixed relation, wherein an x-ray beam emitted by the source is directed across the central aperture;
a plurality of x-ray scintillation detectors mounted on the common gantry in a fixed relation and directed in an opposing orientation relative to the at least one x-ray source, wherein the plurality of x-ray scintillation detectors define an arc having a center located near the at least one x-ray source; and
a plurality of PET/SPECT scintillation detectors mounted on the common gantry in a fixed relation, wherein the PET/SPECT detectors define an arc having a center in common with the central aperture, and wherein the plurality of PET/SPECT detectors are spaced apart from the plurality of x-ray scintillation detectors in a z-direction.

2. The apparatus of claim 1, wherein the common gantry further comprises one degree of freedom in the φ direction.

3. The apparatus of claim 1, wherein the inner perimeter and outer perimeter share a common center.

4. The apparatus of claim 1, wherein the at least one x-ray source emits a fan beam.

5. The apparatus of claim 1, wherein the plurality of x-ray scintillation detectors comprises one or more scintillation crystals selected from cerium doped lutetium yttrium orthosilicate (LYSO), sodium doped cesium iodide (Na:CsI), bismuth germinate (BGO), cerium doped gadolinium orthosilicate (GSO), thallium doped sodium iodide (Tl:NaI), barium fluoride (BaF₂), cerium doped yttrium aluminate (YAlO₃, i.e. YAP), cerium doped lutetium oxyorthosilicate (Ce:Lu₂SiO₅, i.e. LSO), lanthanum bromide (LaBr₃), cerium doped lanthanum bromide, or any combination thereof.

6. The apparatus of claim 5, wherein each of the plurality of x-ray scintillation detectors comprises an array of scintillation crystals optically isolated from each other by reflective media, and wherein the size of the arrays is selected from one or more of 8×8, 16×16, 32×32 64×64 or 128×128.

7. The apparatus of claim 1, wherein PET/SPECT and CT data are collected according to an interlaced pattern.
